(19) United States
(12) Patent Application Publication
(10) Pub. No.: US 2010/0031312 A1
(43) Pub. Date: Feb. 4, 2010

(54) METHOD FOR POLICY BASED AND GRANULAR APPROACH TO ROLE BASED ACCESS CONTROL

(75) Inventor: Sagar S. Dixit, Bibvewadi (IN)

Correspondence Address: ZILKA-KOTAB, PC- IBMS, P.O. BOX 721120, SAN JOSE, CA, 95172-1120, US

(73) Assignee: International Business Machines Corporation, Armonk, NY (US)

(21) Appl. No.: 12/182,041

(22) Filed: Jul. 29, 2008

(51) Int. Cl. G06F 21/00

(52) U.S. Cl. 726/2

(57) ABSTRACT

A method includes receiving input parameters comprising a user identifier, a sensitive command name, and a filename; setting a return code to a default of success; and checking for a global (ANYUSER) entry in a sensitivity database. If there is a global entry in the sensitivity database, the following are performed: comparing the received sensitive command name to a sensitive command in the global entry in the sensitivity database; if the received sensitive command name matches a sensitive command in the global entry, checking for an allow flag or not allow flag; if a not allow flag is found, setting the return code to failure. A check is made for a userID entry in the sensitivity database matching the received user identifier. If the user identifier matches the userID entry, a check is made for an allow flag or not allow flag. The return code is output.

### BACKGROUND

The present invention relates to Role Based Access Control (RBAC), and more particularly, this invention relates to a method for providing RBAC. Role Based Access Control (RBAC) is a new security mechanism introduced in AIX 610. It is an alternative to the all-or-nothing superuser model on Unix systems. AIX V61 is implementing the concept of RBAC and hence most of the utilities and applications running over AIX V61 will benefit from the RBAC model.

RBAC involves administration based on roles assigned to the non root users. However, the approach followed by RBAC's current implementation is not very granular. For example: a user given a role to execute a “chmod” command can execute chmod on any and every file on the system. Although, the super-user will typically be cautious while assigning roles such as these, there could be a case wherein the authorized user could misuse the role and execute chmod on any other file on the system. He may also accidently and unknowingly execute chmod on a file and might not recognize later to execute chmod again to restore the original file access permissions of that file. This applies to application commands as well as, for example, Network File System (NFS) commands like rmnfsexp, rmnfsmnt, etc. and so on. In the NFS case the user having a role to rmnfsexp (unexport an exported directory) can unexport any directory even if he/she has not exported it.

Therefore, it would be desirable to provide granularity in assigning roles of such sensitive commands which will block the authorized users to certain directories or files. For example: a user given “chmod” role should not be allowed to execute chmod on every file on the system. This should be made policy based so that a policy can be set such that a user can be given a role to execute chmod only on a subset of files or directories, or in the NFS case, export or unexport only some directories.

Currently, there is no way to block an authorized user from executing such sensitive commands (like chmod, chown, rmnfsexp, rmnfsmnt etc) to a subset of filesystem. This creates a potential security vulnerability in RBAC enabled Operating Systems.

### SUMMARY

A method includes receiving input parameters comprising a user identifier, a sensitive command name, and a filename; setting a return code to a default of success; and checking for a global (ANYUSER) entry in a sensitivity database. If there is a global entry in the sensitivity database, the following are performed: comparing the received sensitive command name to a sensitive command in the global entry in the sensitivity database; if the received sensitive command name matches a sensitive command in the global entry, checking for an allow flag or not allow flag; if a not allow flag is found, setting the return code to failure. A check is made for a userID entry in the sensitivity database matching the received user identifier. If the user identifier matches the userID entry, a check is made for an allow flag or not allow flag. If an allow flag is found, the received filename is compared to filenames associated with the userID entry. If the received filename matches any of the filenames associated with the userID entry, the return code is set to success; and if the received filename does not match any of the filenames associated with the userID entry, the return code is set to failure. If a not allow flag is found, the received filename is compared to filenames associated with the userID entry. If the received filename does not match any of the filenames associated with the userID entry, the return code is set to success; and if the received filename matches any of the filenames associated with the userID entry, the return code is set to failure. The return code is ouptut.

Other aspects and embodiments of the present invention will become apparent from the following detailed description, which, when taken in conjunction with the drawings, illustrate by way of example the principles of the invention.

### BRIEF DESCRIPTION OF THE SEVERAL VIEWS OF THE DRAWINGS

FIG. 1 is a flow diagram of a method according to one general embodiment.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

The following description provides a methodology for building a framework in which the superuser or the system administrator can restrict RBAC roles given to users for sensitive commands.

Particularly preferred embodiments of the invention incorporate a database (preferably a flat file or a Lightweight Directory Access Protocol (LDAP) server) referred to herein as a Sensitivity Database (SD). Only a superuser or system administrator is allowed to update this database. The SD will host only those users to whom the system administrator wants to allow restricted usage of the sensitive command, where the command added to the SD will be referred to as sensitive command. The RBAC authorized users which are not added to this database continue to follow a standard RBAC security model.

For example, a user having a role to execute “chmod” can be added to this Sensitivity Database by the system administrator. Along with the entry for the user, the database may also hold the list of commands whose roles are assigned to that user and the actual list of one or more directories (or filesystems) to which that command can be allowed to execute. It may also include a Flag called “Allow (A)” or “Not Allow (N)” associated with every file (or directory) which determines if access to that file (or directory) is to be allowed or not allowed.

The Sensitivity Database may thus have the following four columns: User Name Sensitive Command Filesystem/File/Directory Allow/Not Allow Flag.

A new command may be introduced to the system administrator to update the Sensitivity Database. It would be desirable to add only. RBAC-enabled commands to this database. Once an entry is made in the Sensitivity Database, and when the RBAC authorized user executes the sensitive command, the command code checks if that user is authorized to execute the command on the requested file (or directory). This granularity check of restricting the user to a subset of the filesystem adds granularity to the RBAC security mechanism. The Sensitivity Database may be wholly responsible for enforcing this granularity check thus making RBAC more secure and flexible.

Thus if a non-root user is RBAC authorized to execute a sensitive command, and if both the RBAC check and the granularity check pass, that user is allowed to execute the sensitive command. In case a command is not added to the Sensitivity Database for a particular user, then the granularity check may not be performed for that user. Thus a policy can be set for a set of users and commands to increase the granularity of the RBAC and thus make the system more secure.

Several illustrative embodiments are presented below. In particularly preferred embodiments, implementation revolves around the Sensitivity Database.

The Layout of the Sensitivity Database and its Explanation

User ID Sensitive Command Filesystem/File/Directory Allow/Not Allow Flag

As noted above, the Sensitivity Database may have four columns. An illustrative entry in the Sensitivity Database is shown in Table 1, below.

TABLE 1

| | | | Allow (A)/ |
|---|---|---|---|
| User ID | Sensitive Command | File/Directory | Not Allow (N) Flag |
| ANYUSER | /usr/bin/chown | /etc | N |
| 203 | /usr/bin/chmod | /home | A |
| 205 | /usr/bin/chmod | /usr/bin | A |
| | | /home/userxyz | A |
| | /usr/bin/chown | /etc | A |
| 206 | /usr/sbin/rmnfsexp | /export | N |

As seen in the example above, the layout of the Sensitivity Database in one approach includes UserID or uid, Sensitive command name, Filesystem or file or directory to which the user has to be restricted and the Allow/Not Allow Flag which determines whether access to the Filesystem, file or directory is to be Allowed or Not Allowed for that particular user.

The first entry in the Sensitivity Database is ANYUSER, i.e., the policy set in that entry will be applicable to any and every user on that system. In the above example “/usr/bin/chown” is declared a sensitive command on the/etc directory for ANYUSER. The Allow flag is set to N indicating that any user, even though having a “chown” RBAC role, will not be allowed to execute a chown command on the /etc directory. That RBAC authorized user can continue using the chown command on any other file or directory (excluding /etc).

The second entry in the database is for the user having uid=203. This user is RBAC authorized to execute a “chmod” command. But the sensitivity database restricts the user to execute that command only on /home and below (since the Allow/Not Allow Flag is set to A). Thus that user will be allowed to execute chmod on the /home and all the directories below /home. He/she will not be allowed to execute chmod on any other file or directory (except /home and below).

Similarly, the third entry for user having uid=205 allows that user to execute a chmod command on the/usr/bin and /home/userxyz directories since the Allow/Not Allow Flag for both the directories is set to A. Now, this user also has an entry for the “chown” command. This user can execute a chown command on/etc only. Note here that this entry will override the restrictions put by the first entry (ANYUSER). Although ANYUSER entry denies execution of chown on/etc for any user, this specific entry for uid=205 and/usr/bin/chown on/etc with Allow/Not Allow Flag set to A enables the RBAC authorized user (uid=205) to execute chown on/etc. This makes it more policy based (adding more and more granularity).

In the case of NFS, the sensitive commands are the commands which allow a user to export a directory to clients (like exportfs, mknfsexp) and which unexport an exported directory (like rmnfsexp, exportfs-u). Hence, the policy can be set in the Sensitivity Database to allow a user to export only a particular directory or filesystem or even block a user from unexporting a directory or filesystem.

For example, in the Sensitivity Database example above, the last entry for the user having uid=206 will not allow the user to execute rmnfsexp on/export (since the Allow/Not Allow flag is set to N) even though that user (uid=206) has an RBAC role assigned for executing a rmnfsexp command. He/she may continue using a rmnfsexp command successfully on all other exported directories.

The Sensitivity Database preferably allows addition of other commands as well at a later time. An illustrative procedure to add the new command includes making changes in the command code (in user space preferably in main( ) function of the C File of the command) to call the function granularity_check( ). This function checks if the user is allowed to execute that command on the requested filesystem or directory. The check may be performed in Sensitivity Database. Also, an entry is made in the Sensitivity Database for that command with the required restrictions, e.g., only the system administrator can update the sensitivity database. The following new commands may be introduced:

mksd—Add an entry to Sensitivity Database

chsd—Change an entry in Sensitivity Database

rmsd—Remove an entry from Sensitivity Database

The Sensitivity Database (for e.g., a file such as /etc/security/sensitivitycmds) may have permissions such as rw-r-r which allow only the superuser to update it and all other users to only read it.

Algorithm & Flowcharts

The following description will present several illustrative procedures. Note that the steps are presented by way of example only and more, fewer, or other steps may be performed to achieve equivalent results. Moreover, unless otherwise indicated, the order in which the steps are performed is not critical.

Algorithm for Administration

Step 1: Ensure that the command to be added in the Sensitivity Database is RBAC enabled. If not, then first make it RBAC enabled

Step 2: Enter the sensitive command in the Sensitivity Database with the required policy (restrictions)

Step 3: Create an RBAC role for the command and assign it to a non-root user

Algorithm for Sensitive Command Code

Step 1: Call the function granularity_check( ) in the command code (preferably in the main function of the C file of command) and after the RBAC check (checkauths) in user space. The granularity_check( ) may take the following as input parameters:

User ID (uid) of user executing the sensitive command

The sensitive command (path of the command binary)

The filename (file or directory or filesystem to which the user is to be restricted)

Step 2: If granularity_check( ) returns SUCCESS, continue the execution of the command

Step 3: If it returns FAILURE then return FAILURE (error code=EACCESS)

Algorithm for Granularity_Check( )

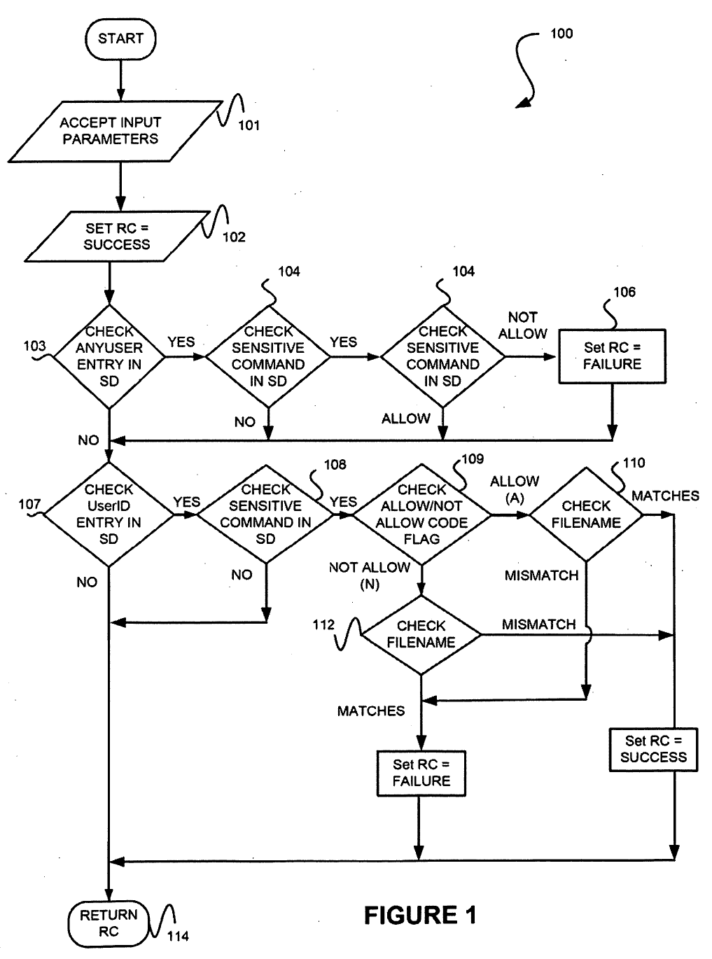

FIG. 1 is a flow diagram illustrating a method 100 according to one embodiment of the present invention. In the flow diagram, “SD” refers to the Sensitivity Database. Preferably, all the checks indicated in the methods are made in the Sensitivity Database.

Step 101: Receive and accept the input parameters namely, a user identifier (UserID), sensitive command name (path) and the filename

Step 102: Set return code (rc) to a default of SUCCESS (rc=success)

Step 103: Check global (ANYUSER) entry in Sensitivity Database.

Step 104: If present, then check if the sensitive command obtained as parameter matches the sensitive command for ANYUSER entry in Sensitivity Database. If sensitive command entry does not match and/or ANYUSER entry is not there, then go to Step 107

Step 105: If ANYUSER entry is present in SD and sensitive command obtained as parameter matches the sensitive command for ANYUSER in SD, then check for ALLOW/NOT ALLOW flag. If ALLOW/NOT ALLOW flag is set to ALLOW then go to Step 107. Else if ALLOW/NOT ALLOW flag is set to NOT ALLOW then go to Step 106.

Step 106: Set RC to FAILURE and go to Step 107

Step 107: Check UserID entry in Sensitivity Database.

Step 108: If present, then check for the sensitive command for that UserId entry

Step 109: If the command is present against that UserID then check for the Allow/Not Allow Flag

Step 110: If Allow/Not Allow Flag is set to Allow A and filename passed to the granularity_check( ) function matches the filename (or below its filesystem heirarchy) in Sensitivity Database for that UserID, then set rc=success and go to Step 114

If Allow/Not Allow Flag is set to Allow A and filename passed to the granularity_check( ) function does not match the filename in Sensitivity Database for that UserID, then set rc=failure and go to Step 114

Step 112: If Allow/Not Allow Flag is set to Not Allow N and filename passed to the granularity_check( ) function does not match the filename in Sensitivity Database for that UserID, then set rc=success and go to Step 114

If Allow/Not Allow Flag is set to Not Allow N and filename passed to the granularity_check( ) function matches the filename (or below its filesystem heirarchy) in Sensitivity Database for that UserID, then set rc=failure and go to Step 114

Step 114: Return the return code (rc), which indicates whether the user can execute a command for the file or not. Particularly, if rc=success, then the user can continue executing the command; if rc=failure, then the user is not allowed to execute the command.

It should be noted that, the invention can take the form of an embodiment containing both hardware and software elements. In one embodiment, the invention may be implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method, comprising:
receiving input parameters comprising a user identifier, a sensitive command name, and a filename;
setting a return code to a default of success;
checking for a global (ANYUSER) entry in a sensitivity database;
if there is a global entry in the sensitivity database:
comparing the received sensitive command name to a sensitive command in the global entry in the sensitivity database;
if the received sensitive command name matches a sensitive command in the global entry, checking for an allow flag or not allow flag;
if a not allow flag is found, setting the return code to failure;
checking for a userID entry in the sensitivity database matching the received user identifier;
if the user identifier matches the userID entry, checking for an allow flag or not allow flag;
if an allow flag is found, comparing the received filename to
filenames associated with the userID entry;
if the received filename matches any of the filenames associated with the userID entry, setting the return code to success;
if the received filename does not match any of the filenames associated with the userID entry, setting the return code to failure;
if a not allow flag is found, comparing the received filename to
filenames associated with the userID entry;
if the received filename does not match any of the filenames associated with the userID entry, setting the return code to success;
if the received filename matches any of the filenames associated with the userID entry, setting the return code to failure;
outputting the return code.
